(19) United States
(12) Patent Application Publication
(10) Pub. No.: US 2015/0371155 A1
(43) Pub. Date: Dec. 24, 2015

(54) METHOD, COMPUPTER PROGRAM, AND SYSTEM FOR PLANNING, RESERVING, AND PURCHASING TRAVEL ACCOMMODATIONS FROM CALENDAR EVENTS

(71) Applicants: Philippe Saint-Just, Miami, FL (US); Umut Tekin, Miami, FL (US); Ari Ojalvo-Oner, Miami, FL (US)

(72) Inventors: Philippe Saint-Just, Miami, FL (US); Umut Tekin, Miami, FL (US); Ari Ojalvo-Oner, Miami, FL (US)

(21) Appl. No.: 14/748,431

(22) Filed: Jun. 24, 2015

Related U.S. Application Data
(60) Provisional application No. 62/016,605, filed on Jun. 24, 2014.

(51) Int. Cl. G06Q 10/02; G06Q 10/10

(52) U.S. Cl. CPC G06Q 10/02; G06Q 10/1093

(57) ABSTRACT

The present invention is directed to a method, computer program, and system for automating the planning, reserving, and purchasing of travel accommodations based on calendar events of a user. A user's event list is created on an application server, which may comprise synchronizing a calendar in at least one embodiment, and a user's booking request is received at the application server for a selected event in the event list. Additional information is then retrieved by an event booking component, and along with the received user's booking request, allows the event booking component to generate at least one travel plan for the user. The travel plan is then reviewed and selected by the user, and then fulfilled by the application server.

### CLAIM OF PRIORITY

The present Non-Provisional patent application claims priority pursuant to 35 U.S.C. Section 119(e) to a currently pending and prior filed Provisional patent application, namely, that having Ser. No. 62/016,605 filed on Jun. 24, 2014, the contents of which are incorporated herein by reference in its entirety.

### BACKGROUND OF THE INVENTION

1. Field of the Invention

The present invention generally relates to a system, method, and computer program for automating the planning, reserving, and purchasing of travel accommodations from a user's prior inputted electronic calendar events.

2. Description of the Related Art

Electronic travel planners relate to specialized electronic search engines utilized to find the best journey between two points by one or more means of transport. Searches may be optimized based on one or more different criteria, such as the fastest, shortest, least layovers, or shortest routes. Constraints may be added to avoid certain way points, to leave or to arrive by a certain time.

Electronic travel planners have traditionally been used by booking agents of the travel industry. However, with the advent of the Internet, publicly available, browser-based self-services have been made increasingly available. Today, the vast majority of travel planner engines are designed to run on personal computers and mobile devices, with travel planning services accessible via web and mobile web.

Due to this increased ease, reduced cost, and popular use of these electronic travel planning services by users online, travel planning engines have been created or readily integrated by a great number of providers, ranging from common carriers, accommodations, and extending to restaurants, entertainment destinations, and hosted events. Extension services have even sprouted up to help a user search through a plurality of travel planning engines in order to find the best travel package for a user, based on user specified input.

However, despite the expansive development in trip planners in various Internet embodiments, one short coming is that the onus of planning every detail of a trip still falls onto the user. In other words, while a known online travel service may allow a user to book travel, accommodation, and other events through a single service, a user still has to manually input each particular travel detail into the system.

Thus, the present invention proposes an improved travel planning, reserving, and purchasing system, method, and computer program by automating various user input and information in order to provide proposed travel plans and destinations to a user, requiring only minimal input, if any, by the user. Accordingly, the present invention is able to decrease the amount of effort required by a user, and therefore increase travel-related purchases.

### SUMMARY OF THE INVENTION

The present invention is generally directed to a method, computer program, and system for calendar-driven or event-driven trip, travel accommodation, and related bookings. Particularly, the present invention may embody a method for accessing virtual calendars of traveler's events stored on third party calendar providers, smart pads, smart phones, and computers to prioritize, reserve and pay through third party payment processors and trip planning reservation processors for parking, transportation, and lodging based on location, date and time of the events.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a method for automating planning, reserving, and purchasing travel accommodations from calendar events for a user to book travel transportation, parking, and lodging based on the events on the user's virtual calendar through an application on a smart phone, smart pad, laptop or desktop computer, allowing the user to attend events based on the location, date and time of the event with the most convenience at the lowest cost.

Another object is to provide a method for automating planning, reserving, and purchasing travel accommodations from calendar events that accesses a user's personal calendar on a smart phone, tablet, laptop, or desktop through the Internet.

Another object is to provide a method for automating planning, reserving, and purchasing travel accommodations from calendar events that allows the event calendar to be accessed and presented in daily, monthly, weekly or list view.

Another object is to provide a method for automating travel accommodations from calendar-driven event booking that allows selection of one or more events from calendar, allowing user to indicate whether the system should book the trip without further confirmation using pre-stored payment information and current location as a starting point.

Another object is to provide a method for automating planning, reserving, and purchasing travel accommodations from calendar events that allows a user to select, reserve and pay for transportation, lodging and parking based on an event using the location of the event as a center point, and using the date/time of the event as the approximate reservation time.

Another object of the invention is to provide a method for automating planning, reserving, and purchasing travel accommodations from calendar events by allowing the user to select one or multiple events and select, reserve and pay for transportation, lodging and parking based on an event using the location of the event as a center point, and using the date/time of the event as the approximate reservation time.

Another object is to provide a method for automating planning, reserving, and purchasing travel accommodations from calendar events that allows the user to view the details of the trip including details of each transportation element forming the trip.

Another object is to provide an a method for automating planning, reserving, and purchasing travel accommodations from calendar events that allows the user the option of using pre-stored payment information to pay for the trip or just parking.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a flowchart illustrating the overall operation of the present invention. Flowchart illustrating the flow of searching, reserving and paying for a trip through the synchronized calendar accessed through the internet.

FIG. 2 is a flowchart illustrating a sub-operation of the present invention. Flow of synchronizing user's calendar.

FIG. 3 is an exemplary user interface illustrating a sub-component of the present invention, directed to the calendar monthly view.

FIG. 4 is an exemplary user interface illustrating a sub-component of the present invention, directed to the calendar list view.

FIG. 5 is an exemplary user interface illustrating a sub-component of the present invention, directed to the event location view.

FIG. 6 is an exemplary user interface illustrating a sub-component of the present invention, directed to a trip options view.

FIG. 7 is an exemplary user interface illustrating a sub-component of the present invention, directed to a trip option details view.

FIG. 8 is an exemplary user interface illustrating a sub-component of the present invention, directed to a trip confirmation view.

FIG. 9 is a block diagram illustrating a sub-component of the present invention. Block view illustrating components communications through the Internet.

FIG. 10 is a diagrammatic representation of an exemplary system for providing calendar event driven travel planning, reserving, and purchasing.

FIG. 11 is a flowchart illustrating a method for calendar event driven travel planning, reserving, and purchasing.

Like reference numerals refer to like parts throughout the several views of the drawings.

### DETAILED DESCRIPTION OF THE PREFERRED EMBODIMENT

### A. Overview

Turning now descriptively to the drawings, in which similar reference characters denote similar elements throughout the several views, the figures illustrate a computer program which embodies a method for accessing virtual calendars of traveler's events stored on third party calendar providers, smart pads, smart phones, and computers to prioritize, reserve and pay through third party payment processors and trip planning reservation processors for parking, transportation, and lodging based on location of the events and current location. Specifically, the present invention provides for an event-driven travel booking method, application, and system which requires minimal input from a user.

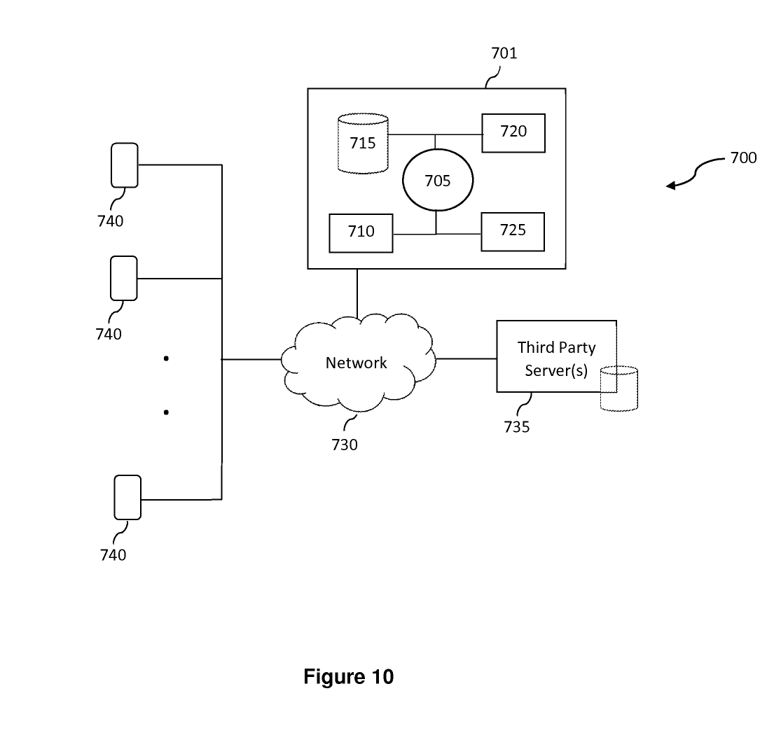

In at least one embodiment, the present invention directed to various methods, systems, and computer programs, may be implemented as part of, or form portion(s) of, a networked system 700 generally represented in FIG. 10. Accordingly, a system 700 of the present invention generally comprises at least one device 740 communicably connected to an application server 701 over a network 730. One or more third party server(s) 735 may further be communicably connected to the application server 701 and the at least one device 740 over the same network 730.

The device 740 may comprise a mobile device, a tablet, a computer, a wearable electronic device, or any other device or combination of circuits structured and configured to communicate with another device, computer, or server over the network 730. The device 740 may comprise application(s) and user interface(s) (front-end interface) that allows a user to interact with the application server 701 and any third party server(s) 735 and stored applications and programs thereon (back-end processing). The user interface may be proprietary and may comprise a custom developed mobile or desktop application. Alternatively, or in addition to, the user interface may comprise a web browser, mobile browser, or other application or executable code that allows for communication and visualization of information, such as in a software-as-a-service (SaaS) embodiment.

The term “application server” 701, “third party server” 735 refer to at least one computer having appropriate hardware and applications installed thereon for the provision of server services including web and other functional services described herein, such that a user may access, execute, and/or view the applications remotely from a device 740. More specifically, the application server 701 and third party server(s) 735 may comprise general purpose computers, specialized computers, or other hardware components structured and configured to receive, process, transmit, and store information to and from other devices. The application server 701 is further configured with executable or interpretable computer code that allows it to perform the processes described within this application.

For example, the application server 701 may comprise a general purpose computer comprising a central processing unit (CPU) 705, which may be a single core or multi core processor, memory 710 (random-access memory, read-only memory, and/or flash memory) or primary memory for high-speed storage of executing programs, electronic storage unit 715 (e.g., hard disk) or secondary memory for storing data, communications interface 720 (e.g., network adapter) for communicating with other devices or computers over a network, and/or peripheral device(s) 725 in communication with the CPU 705 that enable input/output of the application server 701.

The application server 701 may implement the methodology of the present invention using any number of solution stacks (a set of software subsystems or components) known to an ordinary computer or web programmer skilled in the art. These solution stacks may include, without limitation, ZEND Server, APACHE Server, NODE.JS, ASP, PHP, Ruby, XAMPP, LAMP, WAMP, MAMP, WISA, LEAP, GLASS, LYME, LYCE, OpenStack, Ganeti, MEAN, MEEN, XRX, and other past, present, or future equivalent solution stacks, or combinations thereof, known to those skilled in the art that allows a programmer to develop the methods and computer programs described within this application. As such, these solution stacks may be deployed in cloud-based platforms by using known development tools and server hosting services such as GitHub and Rackspace, as well as their equivalents. The third party server(s) 735 may comprise any combination of hardware and software (code segments in any number of programmable, executable, or interpretable languages that support the functionality of the methods described herein) configured to host and transmit calendar items of a user. The third party server(s) 735 may be configured to communicate directly to the application server 701 via application programming interfaces or upon the request of a user.

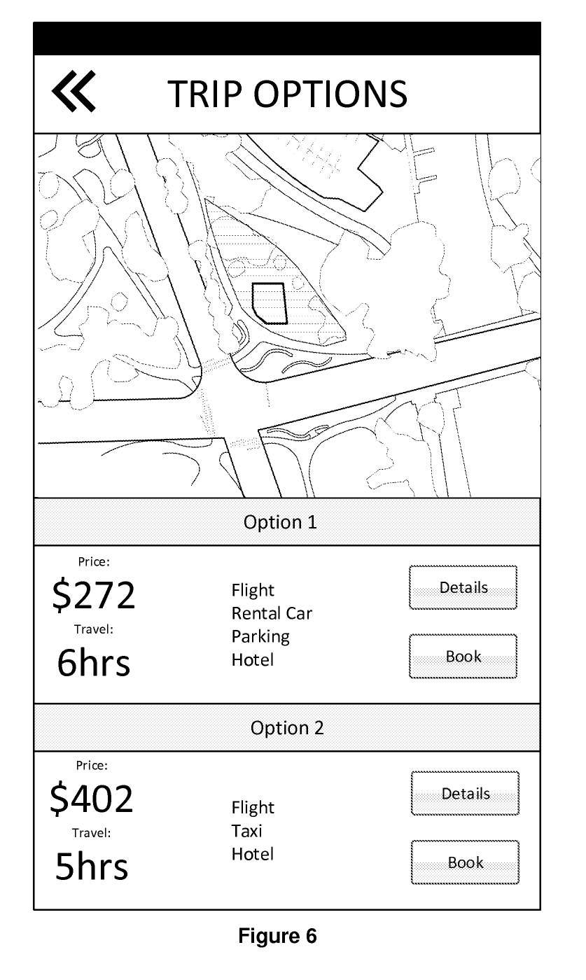

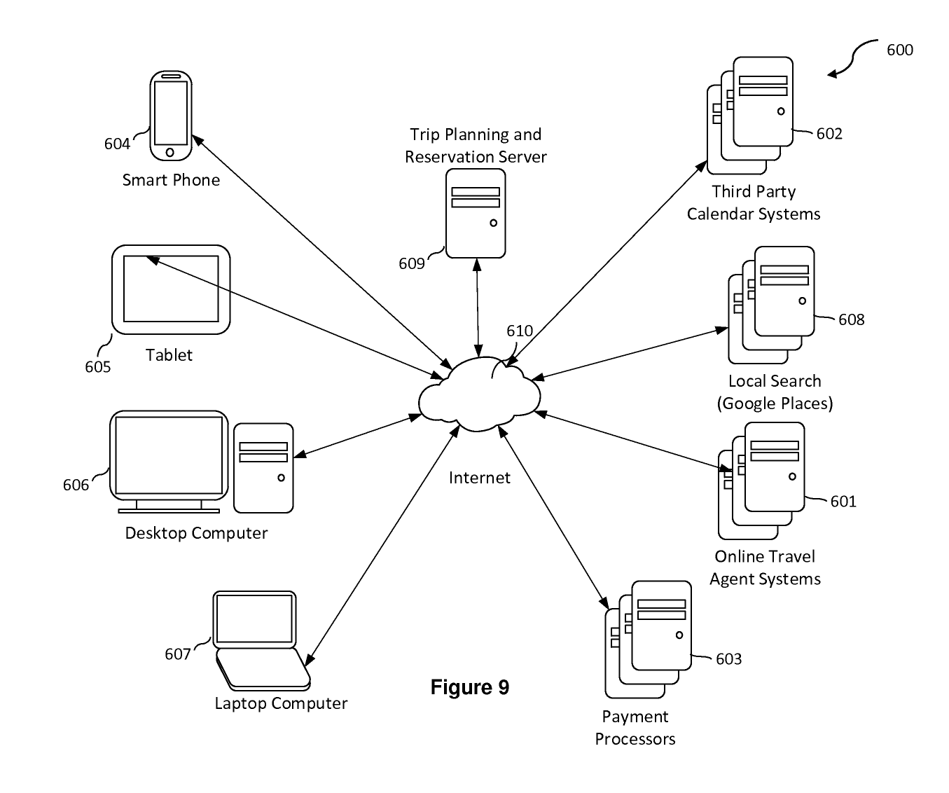

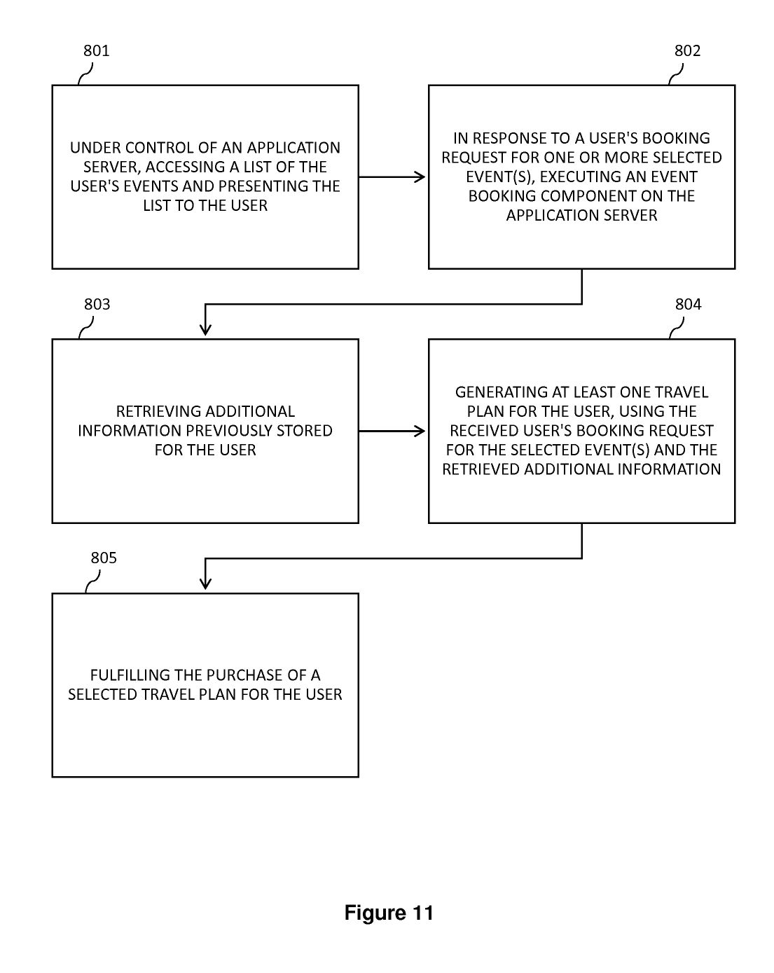

In at least one embodiment, the system 700 in FIG. 10 is equivalent to the system 600 of FIG. 9. Accordingly, the application server 701 of FIG. 10 is synonymous to the Trip Planning and Reservation Server of FIG. 9. The device 740 of FIG. 10 may comprise the smart phone 604, tablet 605, desktop computer 606, and laptop computer 607 of FIG. 9. The third party server(s) 735 of FIG. 11 may comprise third party calendar systems 602, local search 608, online travel agent systems 601, and payment processors 603 of FIG. 6.

The network 730 may comprise at least two computers in communication with each other, which may form a data network such as via LAN, WAN, Serial, Z-WAVE, ZIGBEE, RS-485, MODBUS, BACNET, the Internet, or combinations thereof. The connections may be facilitated over various wired and/or wireless mediums or any combination thereof including interconnections by routers and/or gateways. Network 730 may comprise additional hardware components and/or devices appropriate for facilitating the transmission and communication between the various systems and devices of the present invention, such as those directed to integrated authentication, quality control or to improve content delivery such as via a content delivery network (CDN).

### B. Computer Implemented Method for Accessing and Synchronizing Third Party Calendar(s)

Computer implemented method comprising determining a schedule of events of the traveler using a computer processor, conducting a search for all active events in calendar. In some examples, the traveler provides the system access rights to the traveler's calendar (e.g., Outlook® calendar, Google® calendar, Facebook® calendar), which enables the system to view the calendar of the traveler.

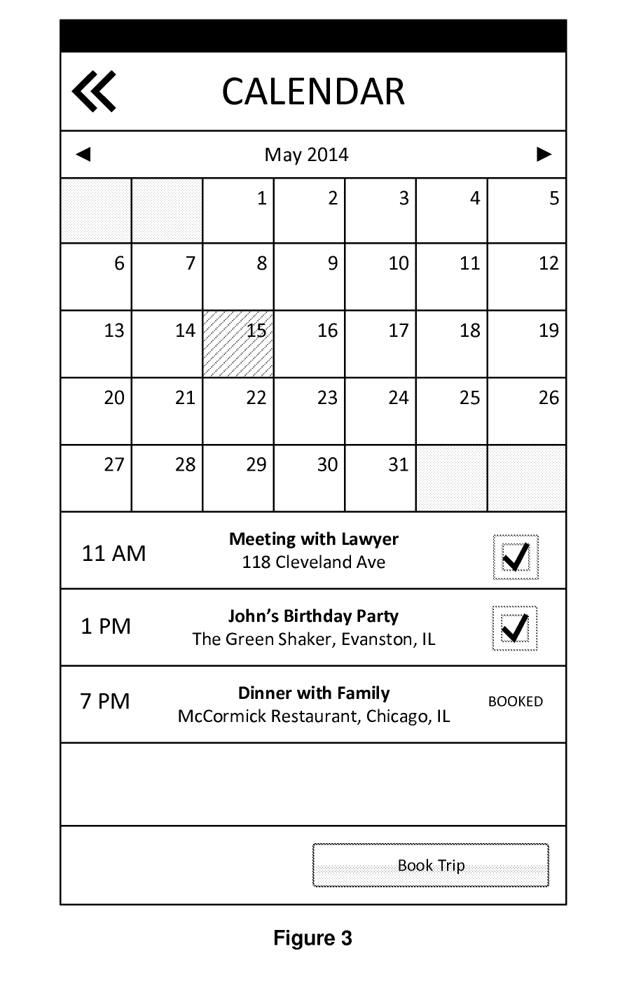

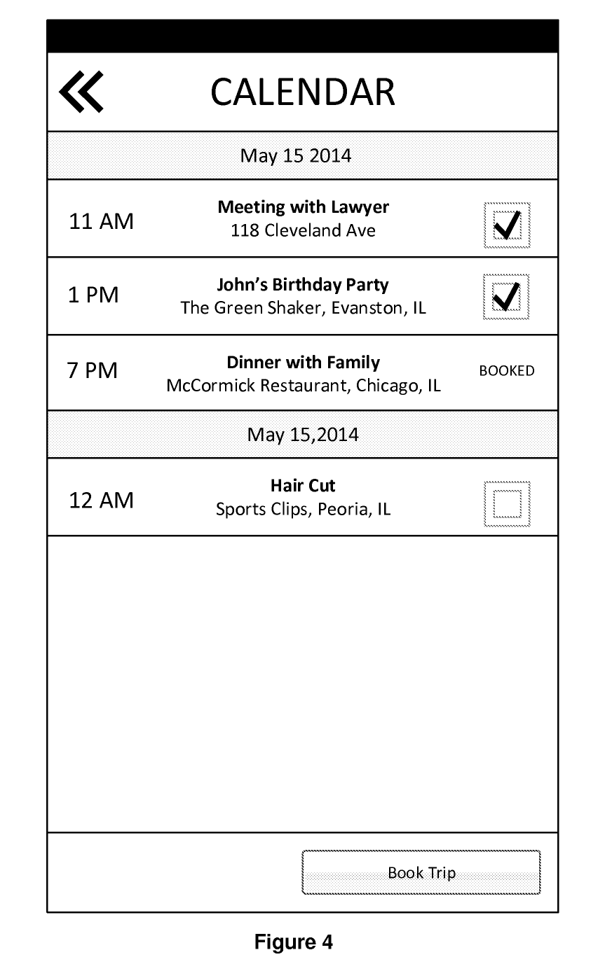

Initially, under control of an application server, a user's calendar may first be synchronized with the application server in order to retrieve the most recently updated events from a user's calendar. Each event from a user's calendar may comprise details such as the event name, the date and time, and the location. The synchronization of a user's calendar may be triggered upon request by a user, or automatically upon a user's login to the service hosted by the application server, or upon access of the calendar view of the present invention such as represented in FIG. 3 or FIG. 4. The synchronization step may involve creating, updating or modifying, or deleting existing events, based on the most recent time stamp of the modification. In at least one embodiment, if there is a conflict or if the system cannot tell which update was the most recent, a user may be prompted for input.

Accordingly, the calendar synchronizing may comprise retrieving or synchronizing data or events from a hosted or service based calendar, such as Google calendar, Facebook calendar, or other services known to those skilled in the art. In these embodiments, the present method may implement application programming interfaces to retrieve data from the user's calendar hosted by the respective service, through that service's servers (i.e. third party server 735). System and/or service access rights may be provided by the user, such as respective API keys or codes that enable authorization of a user's calendar service. The calendar may also comprise device based calendars, such as various native Android, iOS, Windows, OS X, or other calendars for other operating systems. In these embodiments, the present method may directly connect to the respective operating system or software module(s) on various hardware devices, upon a user's authorization of grant of permission if required.

As a non-limiting example in an Android embodiment, all events from all calendars synched with a user's Android device may be fetched using functions and appropriate programmable logic in order to retrieve such information from the Calendar Provider API, or content://com.android.calendar/calendars.

As such, the present invention or system accesses the calendar of the traveler and detects upcoming meetings (dates, times and locations), which may be in other cities, geographical coordinates, or other locational identifiers. The system then determines that the traveler may need to travel from the starting location of the traveler to the destination of a given meeting. In at least one embodiment, a user may be requested to set a default starting location, such as a location of home, work, domicile, or other frequent starting location(s). In other embodiments, the user's starting location may be a current location as determined by a GPS embedded within a device (such as a tablet or mobile phone) used by the user.

The calendar may be presented in different formats including a daily view, a monthly view, a weekly view and/or a listing view showing all events. The system synchronizes the user's calendar by downloading new, updated, and deleted events from the connected third party calendar or device calendar. The application recognizes events on the calendar which occur at different locations and dates and begin the synchronization process and saves results into a computer readable storage medium. The system can be accessed through an application on a mobile device such as a “smart phone”, “smart pad” or laptop which may be equipped with a GPS or other location determination technology.

The method can be implemented with the aid of a computer system having a processor programmed to execute machine readable code that implements the method. As an alternative, or in addition to, a traveler can grant a third party (e.g. distribution partner) access to either a calendar or email(s) of the traveler. The third party can then detect the need for travel (as described above) and offer travel booking options to the traveler.

### C. Computer-Implemented Method for Searching for Travel Arrangements

Computer implemented method for finding travel arrangements for a user, the method compromising (a) determining the travel schedule based on travelers calendar events by identifying text that is indicative of the travel schedule (b) using a computer processor, a computer readable storage medium, or application server as recited above, in order to conduct a search directed to travel options that coincide with the travel schedule (c) selecting one or more travel options from the available travel options from the available travel options.

At least one embodiment of the present invention is directed to a computer-implemented method for making travel arrangements for a user at the application server, the method comprising (a) determining a travel schedule of the user; (b) using a computer processor, conducting a search directed to travel options that coincide with the calendar event and storing available the options in memory; (c) presenting one or more travel options from the available travel options to the user; and (d) receiving the selection of a given travel option from the one or more travel options from the user. In an embodiment, the available travel options are weighted by any two attributes selected from convenience, user review, price and distance.

In another embodiment, in (a), the travel schedule is determined by accessing an electronic calendar of the user and identifying text that is indicative of the travel schedule. The calendar may first be synchronized as described above. In another embodiment, the text comprises a date and destination location.

In another embodiment, determining the travel schedule of the user comprises: receiving an invitation to a meeting from the user, wherein the invitation coincides with a travel schedule of the user; accepting the meeting invitation; and determining the travel schedule from the meeting invitation. In another embodiment, the one or more travel options are selected from the available travel options without any involvement from the user.

In another embodiment, in (c) the one or more travel options are presented on a user interface (UI) of an electronic device of the user, which UI presents a given travel option and at least two attributes of the travel option selected from star rating, user review, price and distance.

As an alternative, the system can access a calendar of the traveler to retrieve details on the travel plan of the traveler or automatically update the calendar with travel booking details. The traveler can provide the system access to the calendar of the traveler by directing the system a meeting invitation.

### D. Computer-Implemented Method for Prioritizing Travel Options

The method comprising of (a) receiving a request from a user for a travel option based on an event on user's calendar, wherein the request comprises a geographic location selected by the user; (b) using a computer processor, searching a database of travel options from a third party trip planning reservation server that matches the location date/time of the events. The method further comprises booking the given travel option without any additional involvement from the user.

The method comprising of (a) receiving a request from a user for a travel option based on an event on user's calendar, wherein the request comprises a geographic location selected by the user; (b) using a computer processor, searching a database of travel options from a third party trip planning reservation server that matches the location and date/time of the event. The method further comprises booking the given travel option without any additional involvement from the user. The method further comprises selecting travel option amenities and service elements that match the one or more travel option preferences. In another embodiment, the one or more travel option preferences comprise user review sentiments. In another embodiment, the match employs the use of a machine learning algorithm that takes user feedback and preferences into account and adapts the matching process based on the preferences. In another embodiment, the travel option can be a hotel, parking or flight or in the alternative any substitute of accommodations, transportation or parking.

### E. Computer-Implemented Method for Processing Reservation and Payment of Travel Options

The method comprising of (a) processing reservation and payment of travel options, wherein the request comprises a geographic location selected by the user; (b) using a computer processor, searching a database of travel options from a third party trip planning reservation server that matches the location of the event. The method further comprises booking the given travel option without any additional involvement from the user.

In one embodiment, the invention provides a method for accepting payments from a traveler for travel options. Such a reservation may after selecting several options, or by selecting the one touch option. Once the reservation is made, the traveler is given a transaction identifier (or record locator) and a payment amount. The payment amount and the transaction identifier are transmitted to a host computer system for validation. This may be accomplished by having the host computer system transmit the transaction identifier to the travel reservation system. If the identifier is located, a confirmation is sent back to the host computer system along with an expected payment. If the expected payment is the same as the payment amount, a validation is received from the host 21 computer system indicating that the transaction requested has been validated.

Following payment, a confirmation may be transmitted to the company that the payment was made by the traveler. Conveniently, the payment may be deposited into a bank account of the company.

In another feature, the validation may further include the expected payment in a currency where the point of sale device is located. In this way, the payment may be made in a local currency. Also, if the expected payment does not match the payment amount, an error message may be transmitted to the point of sale device. The payment amount may then be re-entered at the point of sale device.

In one aspect, the method includes storing a record of the payment and the associated transaction request in a database. Typically, the company desires to know when payment has been made prior to rendering the service. Hence, in one aspect, the method includes receiving an inquiry from the merchant as to whether the payment was made by the consumer, and sending a reply to the merchant in response to the inquiry. Alternatively, the method includes providing an indication to the company that the payment was made by the consumer. This may occur, for example, prior to being prompted by the merchant. The method further may include electronically sending at least a portion of the payment to an account of the company. Another portion of the payment may include a fee or surcharge for the staged transaction service.

As an alternative, the system may not request that the traveler provide payment, but the system can charge the traveler automatically.

### F. Connections of Main Elements and Sub-Elements of Invention

An aspect of the invention provides a method for automating planning, reserving, and purchasing travel accommodations from calendar events. The method comprises determining a travel schedule of the traveler, and conducting, with the aid of a processor, a search directed to travel options that coincide with the traveler's calendar events. The available travel options are then stored in one or more memory locations. One or more travel options are then selected from the available travel options. The traveler then selects the travel options. The one or more travel options can be selected without any involvement from the traveler. This can be achieved based on a deep knowledge of the traveler's preferences which were previously collected and stored. The traveler is then notified of the one or more travel options selected for the traveler.

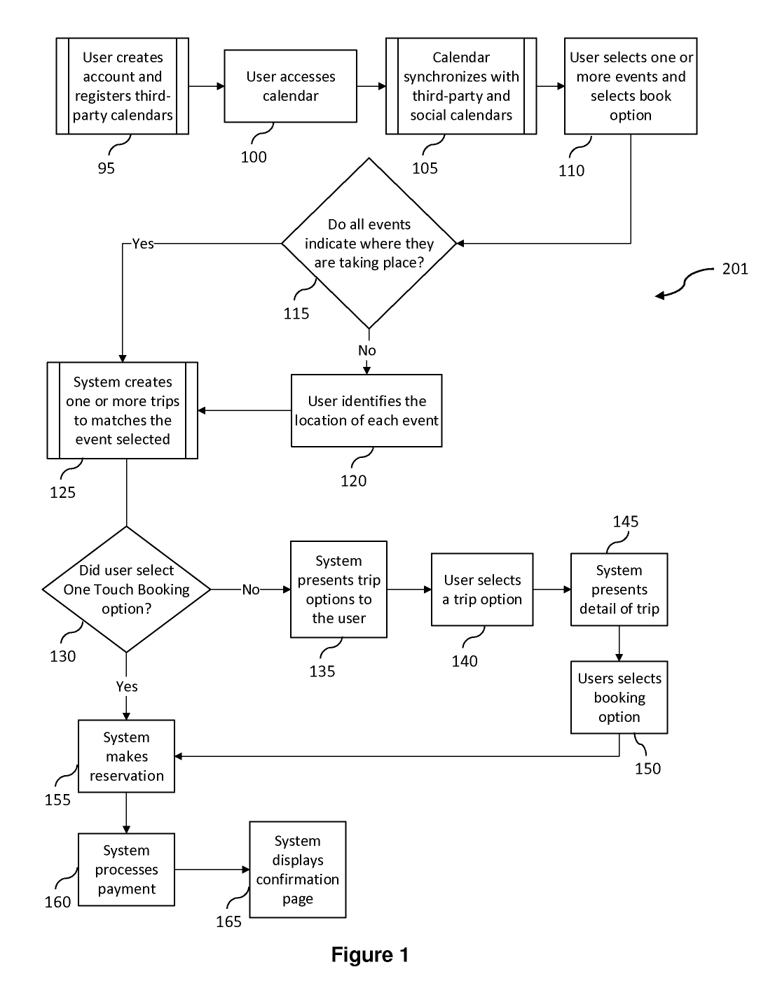

FIG. 1 shows method for automating planning, reserving, and purchasing travel accommodations from calendar events. The method can be implemented with the aid of a computer system having a processor programmed to execute machine readable code that implements the method (see below).

In a preliminary operation, the user inputs registration information into the application form 95, identifying identity information and payment information. In a first operation, the use accesses his or her calendar 100. In a second operation 105, the system synchronizes the traveler's calendar and determines a travel plan (or schedule) of the traveler. The travel plan can include a start date and time and, in some cases, an end date and time of the travel schedule of the traveler. The travel plan can also include a start location (e.g., city, country, address) and a destination location of the travel schedule of the travel. For instance, the travel schedule can include a starting point (e.g., San Francisco, Calif.) of the traveler's travel schedule, and a destination point (e.g., New York, N. Y.) of the traveler's schedule.

In a third operation 110, the system conducts a search for available travel options that coincide with the travel plan and the traveler's preferences. The available travel options can include one or more available travel options, such as, for example, multiple flights. Each of the one or more available travel options can at least partially coincide with the travel plan of the traveler. The one or more available travel options can be stored in one or more memory locations of the system. The one or more memory locations can be coupled to the processor of the system.

In the third operation, 115 the system determines whether the calendars provide locations of where the events are taking place. If the system determines that it does not have sufficient information, 115 it will require the user to input the event.

Next, in a fourth operation 125, the system automatically selects one or more available travel options from the travel options revealed in the search based on the calendar events. The system can either automatically book each travel option for the traveler or let the traveler complete a one-touch (1 touch) booking. In one-touch booking, the system can book any one, two or all three of a transportation, accommodations and parking for the traveler in a single step. For example, the system can book a hotel for the traveler. The system can automatically select various travel options for the traveler, including flight options, hotel options, ground transportation options, and parking options. In some cases, the system can select a travel option for the traveler by directing a notification to a provider of the option (e.g., hotel, airline) that the travel option is to be booked or otherwise reserved for the traveler.

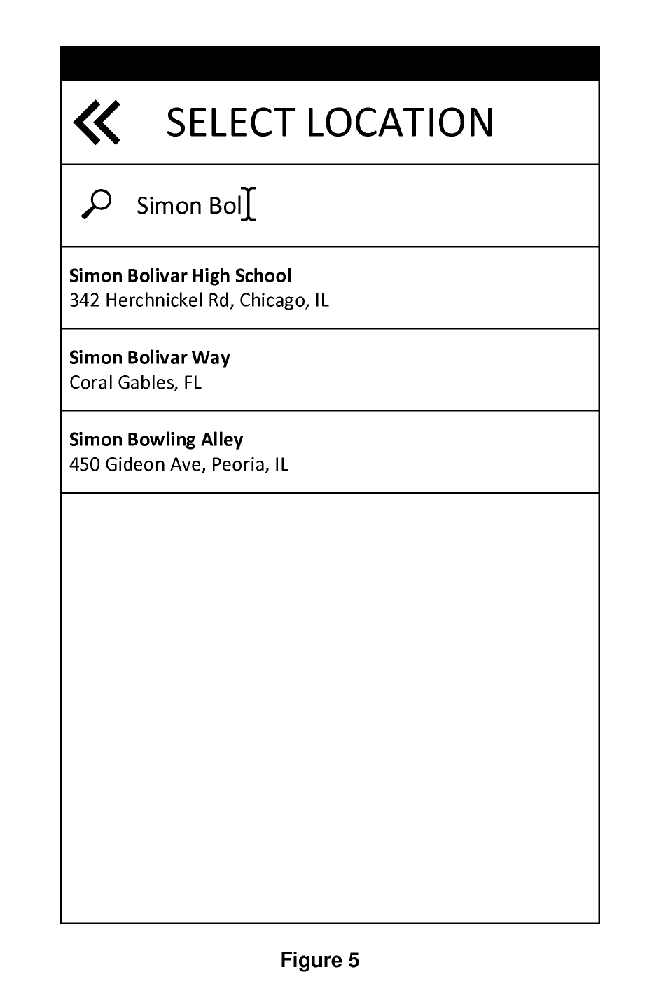

If the traveler chooses not to select the one touch booking option, then, the system provides the traveler with the option, between operations and where the user can select trip options provided by the system and the system can verify options and/or preferences, and/or request additional information from the traveler. For example, the system can inform the traveler as to the average price for a hotel or a flight (see, e.g. FIGS. 5 and 6), and request that the traveler confirm trip details. The system can then receive from the traveler confirmation of trip details or the amount of money the traveler would prefer to pay, and provide the traveler the opportunity to change the traveler's preferences (see, e.g., FIG. 6).

The system can charge the traveler for the transaction including the selection of the one or more travel options. The system can request that the traveler provide payment for the transaction, such as providing electronic funds. As an alternative, the system may not request that the traveler provide payment, but the system can charge the traveler automatically.

The system can determine a travel plan of the traveler by receiving a travel itinerary from the travel. As an alternative, the system can access a calendar of the traveler to retrieve details on the travel plan of the traveler or automatically update the calendar with travel booking details. The traveler can provide the system access to the calendar of the traveler by directing the system a meeting invitation.

The present disclosure provides methods and systems for booking that can involve one or more steps (or involvement steps) from the traveler. In some examples, a traveler is able to book a travel in at most 1, 2, 3, 4, 5, 6, 7, 8, 9, or 10 steps. As an alternative, the traveler is able to book a travel in at least about 0, 1, 2, 3, 4, 5, 6, 7, 8, 9, or 10 steps. For example; the system can book travel options for the traveler with a single authorization step from the traveler (“Book it?”) or without any involvement from the traveler (i.e., 0 steps).

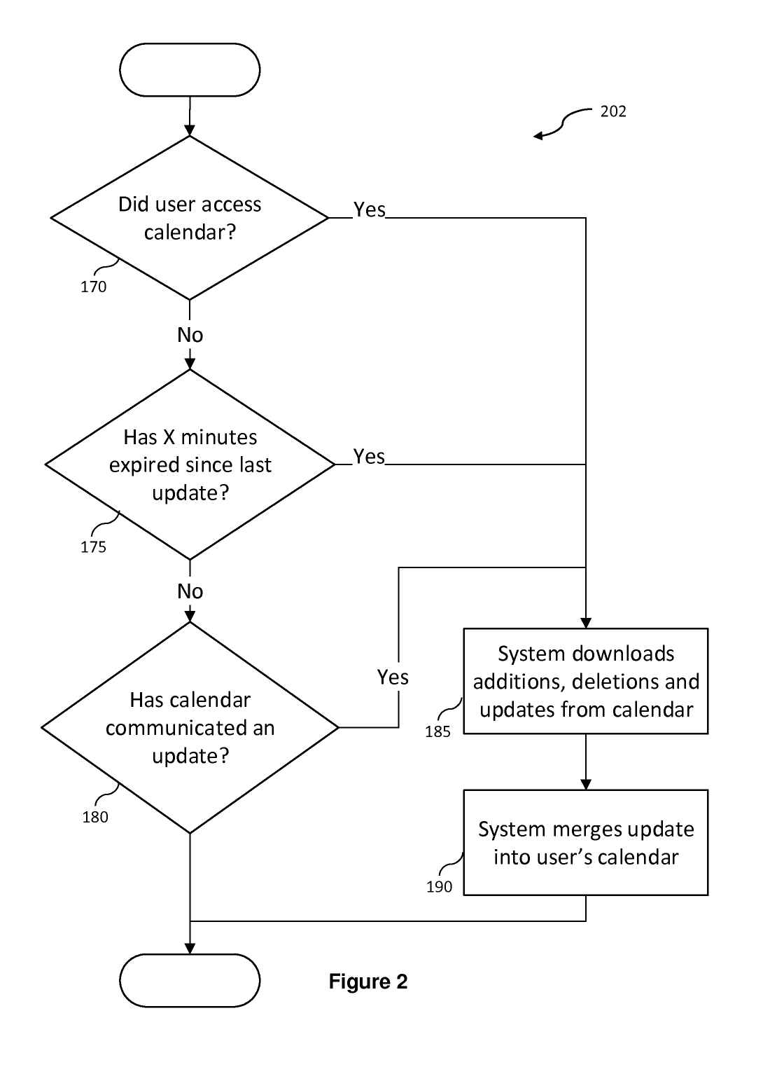

FIG. 2 shows a computer implemented method comprising determining a schedule of events of the traveler using a computer processor, conducting a search for all active events in calendar. In some examples, the traveler provides the system access rights to the traveler's calendar (e.g., Outlook® calendar or Google® calendar, Facebook®), which enables the system to view the calendar of the traveler. The system accesses the calendar of the traveler and detects upcoming meetings (dates, times and locations), which may be in other cities. The system then determines that the traveler may need to travel from the present location of the traveler to the destination of a given meeting. The method can be implemented with the aid of a computer system having a processor programmed to execute machine readable code the implements the method (see below). In a first operation, the user inputs registration information into the application form 100, identifying identity information and payment information. The system 185 then downloads additions, deletions and updates from traveler's calendar and updates the calendar information in the application.

Systems of the present disclosure can be programmed or otherwise configured for proactive travel booking. In some situations, the system detects a traveler's need to travel 6 in a number of ways and automatically offers the traveler booking options. This can be done either directly by the system or through other third parties or third party software (e.g., calendar, email, virtual assistant application and to-do lists), such as partners of the system. In some examples, the traveler provides the system access rights to the traveler's calendar (e.g., Outlook® calendar or Google® calendar), which enables the system to view the calendar of the traveler. The system accesses the calendar of the traveler and detects upcoming meetings (dates, times and locations) 115, which may be in other cities. The system 125 then determines that the traveler may need to travel from the present location of the traveler to the destination of a given meeting. The system then makes traveler arrangements for the traveler, in some cases without any involvement from the traveler. However, the system may request that the traveler authorize the traveler to make a given arrangement. Such authorization may be provided through an electronic message (e.g., email or text message).

As an alternative, or in addition to, a traveler can grant a third party (e.g. distribution partner) access to either a calendar or email(s) of the traveler. The third party can then detect the need for travel (as described above) and offer travel booking options to the traveler. Such booking options can be, for example, offered directly on a travel app 24 on a mobile electronic device of the traveler, which mobile electronic device is in communication with the system. The system can then finalize the booking.

In an example, a traveler using a “To Do List” application indicates the need to book travel. The application may be installed on an electronic device of the traveler that is in communication with a system that is programmed to facilitate the booking of travel arrangements. The system, through the application (e.g., through an application programming interface), can offer the traveler booking options. In some cases, additional questions can be directed by the system to the traveler in order to determine travel dates 7 or other attributes about the trip. Such questions may be asked as part of the booking process.

In an example, the traveler (or a system of the traveler) provides the system an invitation to an electronic meeting on a calendar of the traveler, such as a Microsoft® Outlook®, Yahoo® calendar, Apple iCal® calendar, or Google® calendar. The invitation can include travel criteria of the traveler, such as, for example, a travel start time, end time, start location and end location (“travel parameters”). The system accepts the invitation and searches for and selects travel options that are within the travel parameters set forth in the invitation. As such, the traveler is able to direct the system to conduct a search for the traveler, in some cases with minimal involvement by the traveler.

FIGS. 3 and 4 show screenshots of the calendar views both in day and month views.

FIGS. 5 and 6 show screenshots from an example method for proactively offering personalized flight rental car parking and hotel booking options to a user of a virtual 21 assistant application. A system that is programmed to facilitate travel booking (e. g., the 22 server 601 of FIG. 9) then detects the user's travel plan in the to-do application and offers 23 travel options. The user is able to book the travel options from the application. In FIG. 5, 24 the system provides the user with other travel options that may be relevant to the task.

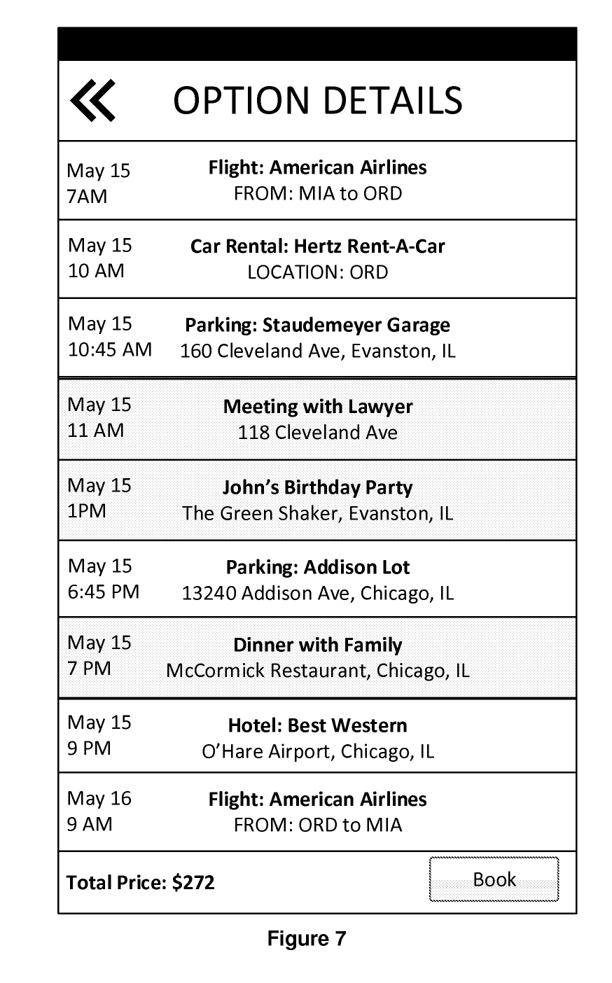

FIG. 7 shows booking option details for flight car rental and parking.

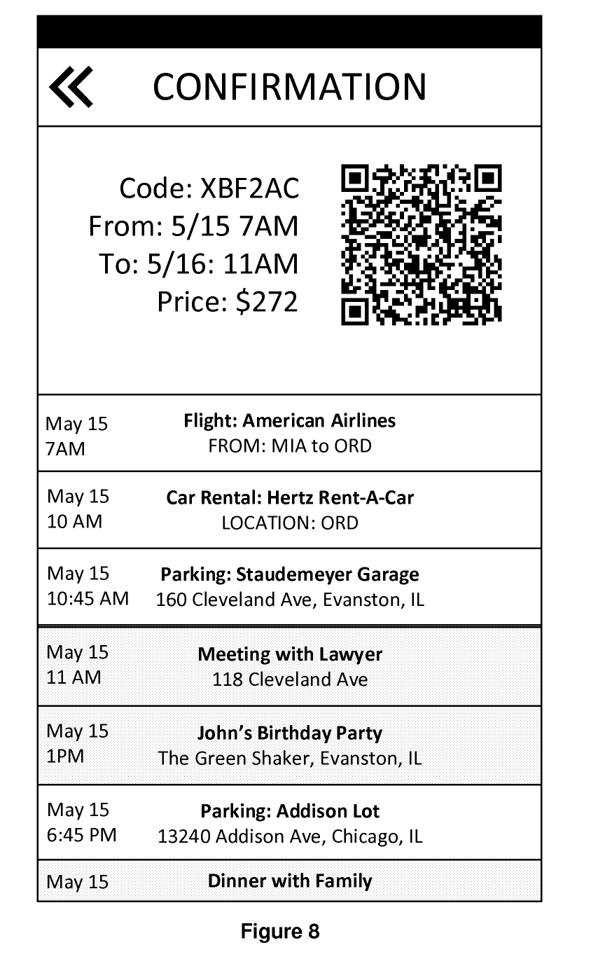

FIG. 8 shows confirmation of the booking for each event.

If the system determines that the user is traveling, the system can make various travel suggestions and enable the user to book one or more of the travel suggestions. For example, if the system detects that the user is going to be travelling to Orlando, Fla. and the system determines that the user has not yet booked a flight or hotel, the system can suggest hotel and/or flight options and provide the user with the opportunity to book (e.g. single touch booking) the hotel and/or flight options. As an alternative, the system can automatically book the hotel and/or flight options for the user.

FIGS. 9 and 10 identify the work flow and communication between traveler's mobile 9 device and the system server.

In some embodiments, a traveler workflow can include at least three phases. In a first phase, a database of synchronized calendar events. In a second phase, the traveler is registered with the system and a traveler profile is created. In a third phase, the system searches for and books travel options for the traveler.

The inventory list can be populated by accessing providers, such as web sites of providers, and retrieving available accommodations. Next, in a second operation 700, the system extracts available attributes and categorizes the inventory based on these attributes. The available attributes can be, for example, address, convenience, and priority. In operation 701, the system collects additional information about the inventory 20 from network sources, such as social media and other available sources (e.g., TripAdvisor®, Facebook®, Twitter®).

In operation 125, the system extracts learning from the inventory categorization. This can include knowledge, such as the average price of a 23 high end hotel at a given location during a particular time of year. In operation 125, the system aggregates inventory information from various sources, such as, for example, from social and non-social sources, to create a comprehensive profile for the inventory items. Next, in operation 130, the system updates an inventory database of the system or in communication with the system. The database can be updated with relevant attributes and historical trends for use when a traveler goes through the booking process. The system can select from available travel options from a database created by the system. The system can be as described elsewhere herein 701 (see, e.g. FIG. 9).

In some situations, categorizing hotel and flight inventory may be based on attributes so that the system can match traveler preferences to the available inventory. The system in some cases may start with hotel inventory and later expand to other 8 inventory, such as, for example, flights, car rentals, activities, restaurants and 9 transportation. The system can use at least two types of inventory: the overall inventory that may be categorized and the available inventory at any given point in time. While a hotel may exist, it may not be available at a given point in time. The system can collect accommodations attributes in a number of ways. The system can collect inventory information about accommodations from an online travel agency (OTA) or multiple OTA's, or emerging lodging solutions from the accommodation website or from other sources. Attributes that the system can collect about inventory include: price band (i.e., whether the accommodation typically fall into a specific price band, such as, e.g., expensive or cheap), the star rating of the accommodation, customer reviews (e.g. Yelp® reviews, Hotel.com®, or Airbnb® reviews), amenities, accommodation chain, type(s) of room (e.g., smoking or non-smoking), bed sizes, type of accommodations (e.g., business, vacation, family), whether hotel price fluctuates throughout the year, whether there are preferable days and times to book the hotel, points of interest in proximity to the hotel, whether the hotel is at a location that may be considered of interest to travelers (e.g., accommodation is in the center of town).

As an alternative, the system can collect indirect information and inferred information about the accommodation. Indirect information can include travelers who post information on either review sites, accommodation information on network web sites (e.g., Facebook®, Twitter®, Google+®), current information about accommodation amenities. The system can monitor activity on a social media web site for information that may be relevant to the hotel. Inferred information can include grouping accommodations into clusters based on their attributes, and using cluster analysis to infer an attribute of a given accommodation based on attributes of the cluster. This can preclude the need to 9 collected detailed information about every accommodation in the cluster. Cluster analysis can show which attribute show up most often and which preference combinations are most common. In some cases, the system identifies the common preference groups and determines if it makes sense to tag a given group as a distinct group. The system can then assign am accommodation to the group.

The system can collect accommodation inventory information by continuous discovery and learning. The system can continuously update the database of the system with accommodation information by periodically sampling OTA data or other sources of data and detecting a change with respect to information available in the database. In some cases, the system updates indirect information from social media providers or other network providers to identify information that is otherwise not available. Once the system collects this information, the system can perform an analysis on attributes, which may enable the system to filter attributes to optimize the hotel recommendation process.

As illustrated and revisited in FIG. 10, another aspect of the invention provides systems programmed to implement methods of the disclosure. FIG. 6 shows an example system 700 adapted to automatically make travel arrangements for a traveler, in accordance with an embodiment of the invention. The system 700 includes a central computer server or application server (“server”) 701 that is programmed to implement methods of the disclosure. The server 701 includes a central processing unit (CPU, also “processor” and “computer processor” herein) 705, which can be a single core or multi core processor, or a plurality of processors, such as for parallel processing. The server 701 also includes memory 710 (e. G., random-access memory, 10 read-only memory, flash memory), electronic storage unit 715 (e.g., hard disk), communications interface 720 (e.g., network adapter) for communicating with one or more other systems, and peripheral devices 725, such as cache, other memory, data storage and/or electronic display adapters. The memory 710, storage unit 715, interface 720 and peripheral devices 725 are in communication with the CPU 705 through a communications bus (solid lines), such as a motherboard. The storage unit 715 can be a data storage unit (or data repository) for storing data. The server 701 can be operatively coupled to a computer network (“network”) 730 with the aid of the communications interface 720.

The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730 in some cases, with the aid of the server 701, can implement a peer-to-peer network, which may enable devices coupled to the server 701 to behave as a client or a server.

The storage unit 715 can store files, such as filed related to traveler profiles and/or accounts, and service provider (e.g., airlines, hotels) profiles. The server 701 in some cases can include one or more additional data storage units that are external to the server 701, such as located on a remote server that is in communication with the server 701 through an intranet or the Internet.

The storage unit 715 can store user travel information, including past travel information, current travel information and future travel information. The storage unit 715 can store information of or related to a traveler, such as the traveler's travel preferences, including the traveler's likes and dislikes with respect to travel options (e.g., favorite hotel, favorite airline, preferred food, preferred flight times).

The storage unit 715 can store traveler and service provider data that has been aggregated by the server from one or more sources, such as network sources. The sources can include social media web sites (e.g., Facebook®, Foursquare®, Google+®, LinkedIn®, Instagram®), and content that may be available on the Internet, as may be retrieved with the aid of search engines (e.g., Google®, Yahoo®, Microsoft® Bing).

The server 701 can communicate with one or more remote computer systems through the network 730. In the illustrated example, the server 701 is in communication with a first computer system 735 and a second computer system 740 that are located remotely with respect to the server 701. The first computer system 735 can include a database for recording traveler travel information, and the second computer system 740 can be a computer system of a traveler. In some situations, the second computer system 740 may not be part of the system 700, but may be configured to interact with the system 700.

However, in situations in which the second computer system 740 is a remote terminal, such as a remote administration terminal, the second computer system 740 may be part of the system 700. The first computer system 735 and second computer system 740 can be, for example, personal computers (e.g., portable PC), slate or tablet PC's (e.g. Apple® iPad, Samsung® Galaxy Tab), telephones, Smart phones (e.g., Apple® iPhone, Android-enabled device, Blackberry®), or personal digital assistants.

In an example, the second computer system 740 is a portable electronic device of a user (e.g., traveler) that wishes to have the server 701 automatically make travel arrangements for the user. The server 701 can conduct a search for travel options and select one or more options that meet travel criteria of the user, and provide the second computer system 740 of the user a travel itinerary or plan. The search results can be displayed on a graphical user interface of the second computer system 740.

In some situations the system 700 includes a single server 701. In other situations, the system 700 includes multiple servers in communication with one another through an intranet and/or the Internet.

The server 701 can be adapted to store user profile information, such as, for example, a name, physical address, email address, telephone number, instant messaging (IM) handle, educational information, work information, social likes and/or dislikes, travel likes and/or dislikes, service provider (e.g., airline, hotel) preferences, restaurant preferences, and historical information of past travel of the user (which may include travel booked by the system 700), and other information of potential relevance to the user or other users. Such profile information can be stored on the storage unit 715 of the server 25 701.

Methods as described herein can be implemented by way of machine (or computer processor) executable code (or software) stored on an electronic storage location of the server 701, such as, for example, on the memory 710 or electronic storage unit 715. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710. Alternatively, the code can be executed on the second computer system 740 of the user.

The code can be pre-compiled and configured for use with a machine have a processor adapted to execute the code, or can be compiled during runtime. The code can be supplied in a programming language that can be selected to enable the code to execute in a pre-compiled or as-compiled fashion. The code may also comprise interpretable code that do not require compilation.

Although the system 700 includes a single server 701, the system 700 can include multiple servers. The servers of the system 700 can be implemented in a distributed computing fashion. In some example, the system 700 can be implemented via cloud computing using one or more servers.

Aspects of the systems and methods provided herein, such as the server 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. Shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or 26 light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some cases, the server 701 can be configured for data mining, extract, extract, transform, and load (ETL), or spidering (including Web Spidering or crawling where the system retrieves data from remote systems over a network and access an Application programming interface or parses the resulting markup) operations, which may permit the system to load information from a raw data source (or mined data) into a data warehouse. The data warehouse may be configured for use with a business intelligence system (e.g., Microstrategy®, Business Objects®). The media file management system can include a data mining module adapted to search for media content in various source locations, such as email accounts and various network sources, such as social networking accounts (e.g., Facebook®, Foursquare®, Google+®, LinkedIn®) or on publisher sites, such as, for example, weblogs.

Travel details and other communication to or from the system can be presented to the traveler with the aid of a user interface (UI), such as a graphical user interface (GUI), on an electronic device of the user. The UI, such as GUI, can be provided on a display of an electronic device of the user. The display can be a capacitive or resistive touch display, or a head-mountable display (e.g., Google® Goggles, Google® Glasses). Such displays can be used with other systems and methods of the disclosure.

Methods of the disclosure may be facilitated with the aid of applications (apps) that can be installed on electronic devices of users. An app can include a GUI on a display of the electronic device of the user. The app can be configured to perform certain functions of the system, such as, for example, permitting a traveler to search for travel options.

A UI can be presented on a display of an electronic device of a user. The UI can present one or more travel options, such as flight and hotel options. The options can include attributes, such as, for example, star rating of travel option, user review of the travel option, price of the travel option and distance of the travel option from a geographic location of the traveler.

### H. Operation of Exemplary Embodiments of the Present Invention

1. User creates account on system (application server) using one of several methods
a. User provides personal information such as first name, last name, and email address. User selects a password that will be used to identify the user.
b. User provides his user identifier and password for a third party partner such as Facebook, Google, etc. System connects to partner to validate the user's information and downloads the user's personal information from the partner.

2. User links his account to third-party calendar providers. The process varies according to the calendar provider. The process typically consists of the user providing his authentication information for the third-party and agreeing to share his information with the system.

3. If the system is accessed through a mobile application, user authorizes the system to access the calendar module on the mobile device.

4. User accesses his personal virtual calendar
a. Calendar can be accessed on a smartphone, tablet, laptop or desktop computer
b. Calendar may be presented in different formats:
   i. A daily view
   ii. A monthly view
   iii. A weekly view
   iv. A list view showing all events

5. System synchronizes the user's calendar by downloading new, updated and deleted events from connected third-party and mobile calendars
a. User has previously identified which third-party and social calendars should be synchronized and provided the credentials to do so.
b. On smartphone devices, the system can connect to the calendar module on the device

6. User selects one or more events from his calendar to indicate for which events he would like the system to provide trip solutions which will allow him to attend all events and presses the submit button.
a. User can optionally select the “Book Now” option to can indicate whether the system should book the trip without further confirmation using pre-store payment information

7. For each event, system provides an input area for the user to identify where events are taking place. User enters identifying information of the location (such as name, city, zip code or address). If the information entered by the user matches multiple locations, the user is presented with suggestions. User selects correct suggestion.
a. If the information about the event in the calendar already contains uniquely identifying information about the location where the event is taking place. The system will retrieve the information and the user will not be asked to provide the location for the event.

8. System executes algorithm to create zero or more trip options
a. A trip option is composed of one or more logistics segments of one of several types:
   i. Transportation solution. Includes but is not limited to Airplane flight, Rental car, Taxi, Bus, Train, Ferry
   ii. Parking solution
   iii. Cruise ship solution
   iv. Lodging solution. Includes but is not limited to hotels and private rooms.
b. The logistics segments are selected to provide the user with an overall logistics solution that will allow him to physically attend all the selected events.
c. Logistics segments are selected to be complimentary to other logistics segments in the trip option according.
d. The trip option may return a partial overall logistics solution if the system cannot provide a solution for individual logistics segments.
e. System calculates total price of trip option.

9. System displays trip option results to user. Trip options are presented in a list format displaying summary information about each trip option including duration and price.

10. User selects trip option

11. System displays details of trip option
a. System displays summary information about the trip including duration and price.
b. System displays the list of logistics segments in the trip. System display the type of the segment, the duration, the price and the company providing the segment.

12. User selects booking option

13. If the user has not previously entered his payment information, user enters payment information.
a. User selects the method of payment. Payment methods include but are not limited to credit card.
b. User enters required information for payment method.

14. System processes user payment.

15. For each logistics segment in trip option, if the logistics segment can be reserved, the system processes the reservation.
a. If a logistics segment can be reserved in the system of a third-party partner, system connects to third-party partner and processes reservation.

16. System displays confirmation information about his booking.

In at least one embodiment of the present invention, a method for planning, reserving, and purchasing travel accommodations from calendar events may comprise, under control of an application server, accessing a list of the user's events and presenting the list to the user, as in 801. The application server may comprise 701 as described above, the methodology implemented using a solution stack described above in this application, such as a LAMP development environment.

In one embodiment, the accessing step 801 may comprise accessing data that were previously transmitted to and stored at the application server. For example, the user event(s), as represented at FIG. 3 and FIG. 4, may have been manually and/or directly inputted by a user to the application server via a user interface, including a description, location, date, time, and/or other related travel information, notes, or data. This manual entry may involve the filling in of input forms provided to the user, or by way of uploading a calendar file such an iCalendar (.ics) file, vCalendar (.vcs) file, csv file, or other file comprising event/scheduling appropriate, readable, and/or parsable fields of text or data.

In one embodiment, the accessing step 801 may comprise synchronizing a user's calendar, the calendar comprising at least one event. The synchronizing step may comprise updating a user's calendar with a third party calendar service, or updating the user's calendar with a user device. The user's calendar is preferably stored on the application server 701 such that this same calendar may be used for booking across a plurality of different devices. In one embodiment, the synchronizing step may conduct a logic check, and only update a user's calendar if a predetermined amount of time has expired since the previous update, this is to avoid being blocked from third party calendar service(s) if a user updates the calendar too frequently through respective third party APIs. Different predetermined amount of times may be set separately, depending on which third party calendar service is being utilized. In one embodiment, the synchronizing step may operate as described in Section B above.

Next, in response to a user's booking request for one or more selected event(s) in the calendar, the application server executes an event booking component, as in 802. In one embodiment, the event booking component executes the instructions as described in Section C above. Accordingly, the application server may perform operations to parse and/or identify the text or other location identifiers indicative of the location and/or date of the user selected event from the calendar. If the location and/or date cannot be determined, then the application server may prompt the user for further input.

In at least one embodiment, the user's booking request includes only a single action being performed on a client system in communication with the application server, or a “One Touch Booking” option as illustrated in FIG. 1 and described above. Client system is synonymous with device 740 in accordance to FIG. 10, including any required software required to communicate with the application server 701, which may include a native application custom developed, or a web browser configured to communicate with the web services offered by the application server 701. The “single action” refers to a single request received by the application server 701. For example, drawing attention to FIG. 3 and FIG. 4, a “single action” from the user perspective may involve selecting at least one event on the user's calendar, and clicking or otherwise interacting with the “Book Trip” button. This constitutes as performing a single action by the user. In at least one embodiment, a plurality of events on a user's calendar may be selected, such that a user may book a plurality of events and trips with a single action received by the application server 701.

Of course, in other embodiments, rather than a checkbox selection, a button or other interactive graphic may appear next to an event in the user interface, such as a “Book It Now” button. Upon effecting this single action, the application server will process the remaining steps of the event booking component recited below (i.e., retrieving additional information, generating a travel plan, and fulfilling the purchase) without requiring any further input from the user.

The execution of the event booking component may comprise retrieving additional information previously stored for the user, as in 803. In one embodiment, the additional information may be associated with a user account the user had previously registered and/or created with the application server. In one embodiment, the user registration may occur in accordance with Section F and/or FIG. 1 above. The additional information may comprise a starting location of the user, such as to utilize in generating a travel plan as the starting point. One or more starting locations may be predetermined, i.e. previously inputted by a user on the application server, as the user's “home”. A plurality of these starting locations may be entered. In one embodiment, the starting location may be automatically determined by a GPS embedded or connected to a user device the user is using to access the application server.

In one embodiment, additional user information may further comprise user preferences, which may include, without limitation, a price range or preferred price point for one or more of travel, lodging, car rental, or other related or ancillary travel services that may form part of a trip itinerary; preferred common carrier names; preferred common carrier types, such as train, ship, plane, bus, etc.; preferred travel days of the week; preferred maximum number of layovers; preferred destinations; preferred detours; preferred restaurants; preferred payment methods or stored financial transaction methods, such as credit card numbers and payment information; and other data points that may be utilized as input for generating a travel plan.

In one embodiment, these additional user information may be previously inputted by a user on the application server, by way of input forms and user interfaces, or bay way of previous bookings such as to establish a previous travel history associated with the user stored on the application server database. Additional user information may also include data mined from the user's online presence or accounts with third party service(s) such as Google Plus, Facebook, Twitter, LinkedIn, and the like discussed above. This data may be mined from a user's account and shared information, such as, for example, the types of “Likes” and “Dislikes” of lodgings, accommodations, common carriers, locations, events, and other appropriate and relevant data points that are readable or shared with the application server. This information may be extrapolated by readily available APIs, custom built ETLs, or a web or data crawling component built on to, or in communication with, the application server.

At least one travel plan is then generated for the user, as in 804, using the received user's booking request for the selected event, and the retrieved additional information for the user. In one embodiment, this step 804 may comprise the operations described above in Section F and/or FIG. 1. Accordingly, the application server and more particularly the event booking component thereof, may execute an inventory search of connected services, including online travel agent system 601 as illustrated in FIG. 6, local search services 608 such as Google Places, as well as any other third party server(s) or services for providing an inventory of travel accommodations, including but not limited to travel options such as airfare, bus fare, train fare, cruise fare; lodging such as hotel, camping, apartment reservations; restaurant or event reservations; rental car reservations; parking reservations; and other travel-related reservations. Examples of these third party server(s) and services may include TripAdvisor, AirBnB, Hotels.com, Kayak.com, United.com, Delta.com, OpenTable.com, Ticketmaster.com, and other equivalents thereof.

In an embodiment where the user's booking request includes only a single action being performed on a client system, greater reliance is placed upon the retrieved additional information. Therefore, in this embodiment, the starting location, as well as one or more of the above preference information, is utilized in automatically selecting the “best” trip for a particular user, based on his or her preference profile, and payment information stored for the user. These additional information may also be retrieved from the partner sites above, and from any user accounts of these partner sites, server(s), or services, linked to the application server of the present invention.

The purchase of the selected travel plan is then fulfilled, as in 805, in order to complete the user's booking request. In one embodiment, the operations may occur as described above in Section F and/or FIG. 1. Accordingly, in one embodiment, a user may stipulate the method of payment, such as by credit card, PayPal, or other known financial service providers. In a single action booking embodiment, as discussed above, the application server may simply utilize the default payment option the user had stored, and pre-selected, on the application server. In executing the purchase, the application server will communicate with appropriate third party travel inventory providers, intermediaries, as well as financial services as appropriate, in order to finalize a purchase transaction. Confirmation may be received by the application server from one or more of the third party service(s) or server(s), and thereafter, a confirmation, as illustrated in FIG. 8, may be sent to the user comprising relevant and appropriate information indicating success of purchase, including transaction or confirmation numbers, travel details, and other travel data.

Individual components or elements of the system and method may be used interchangeably. The order of the method or processes described above may be arranged in any combination in various embodiments. In some embodiments, various steps may be omitted.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for planning, reserving, and purchasing travel accommodations from calendar events, said method comprising:
under control of an application server,
accessing a list of the user's events and presenting the list to the user;
in response to a user's booking request for one or more selected event(s), executing an event booking component on the application server, the execution comprising:
retrieving additional information previously stored for the user;
generating at least one travel plan for the user, using the received user's booking request for the selected event(s) and the retrieved additional information;
fulfilling the purchase of a selected travel plan for the user in order to complete the user's booking request.

2. The method of claim 1 wherein the accessing step comprises synchronizing a user's calendar, the calendar comprising at least one event.

3. The method of claim 2 wherein the synchronizing step comprises updating the user's calendar with a third party calendar service hosted by a third party server.

4. The method of claim 2 wherein the synchronizing step comprises updating the user's calendar with a user device.

5. The method of claim 4 wherein the synchronizing step further comprises updating the user's calendar only if a predetermined amount of time has expired since the previous update.

6. The method of claim 5 wherein the synchronizing step updates the user's calendar regardless of the amount of time since the previous update, when an update is communicated from a third party calendar service hosted by a third party server.

7. The method of claim 1 wherein the user's booking request includes a single performed action on a client system in communication with the application server.

8. The method of claim 1 wherein the additional information retrieved by the event booking component comprises a starting location of the user.

9. The method of claim 8 wherein the additional information retrieved by the event booking component further comprises payment information of the user.

10. The method of claim 1 wherein the event booking component is further configured to retrieve, generate, and fulfill the purchase of a plurality of selected travel plans for a plurality of given events in the calendar.

11. The method of claim 1 wherein the generated travel plan comprises a transportation solution.

12. The method of claim 11 wherein the generated travel plan comprises a parking solution.

13. The method of claim 12 wherein the generated travel plan comprises a lodging solution.

14. The method of claim 1 wherein the generated travel plan comprises a total price.

15. The method of claim 14 wherein the generated travel plan comprises a travel duration.

16. The method of claim 1 wherein the generated travel plan is created based at least in part on a user preference profile.

17. The method of claim 16 wherein the user preference profile comprises data points retrieved from the user's past travel history stored on the application server.

18. The method of claim 17 wherein the user preference profile comprises data retrieved from the user's account on third party services.

19. A computer program on a non-transitory computer readable medium, for execution by an application server for planning, reserving, and purchasing travel accommodations from calendar events, said computer program comprising:
an event list code segment configured to receive and store a list of events associated with a user and present the list of events to the user;
an event booking code segment configured to:
in response to a user's booking request for one or more selected event(s),
retrieve additional information stored for the user;
generate at least one travel plan for the user, using the received user's booking request for the selected event(s) and the retrieved additional information;
fulfill the purchase of a selected travel plan for the user in order to complete the user's booking request.

20. A system for planning, reserving, and purchasing travel accommodations from calendar events, said system comprising:
an application server configured with a plurality of code segments thereon, including:
an event list code segment configured to receive and store a list of events associated with a user and present the list of events to the user;
an event booking code segment configured to:
in response to a user's booking request for one or more selected event(s),
retrieve additional information stored for the user;
generate at least one travel plan for the user, using the received user's booking request for the selected event(s) and the retrieved additional information;
fulfill the purchase of a selected travel plan for the user in order to complete the user's booking request.
at least one device communicably connected to the application server over a network, said at least one device cooperative configured to access the functionality provided by said plurality of code segments stored on said application server.
